(19) United States
(12) Patent Application Publication
(10) Pub. No.: US 2026/0219165 A1
(43) Pub. Date: Jul. 30, 2026

(54) MODEL GENERATION DEVICE, PREDICTION DEVICE, AND PROGRAM

(71) Applicant: NTT, Inc., Tokyo (JP)

(72) Inventors: Akira ITO, Tokyo (JP); Yosuke TAKEUCHI, Tokyo (JP); Daisuke UCHIBORI, Tokyo (JP); Fumito KUDO, Tokyo (JP); Junichiro TAMAMATSU, Tokyo (JP)

(73) Assignee: NTT, Inc., Tokyo (JP)

(21) Appl. No.: 19/146,506

(22) PCT Filed: Jan. 11, 2023
(86) PCT No.: PCT/JP2023/000501

§ 371 Date: Jul. 8, 2025

(51) Int. Cl. G01N 17/00

(52) U.S. Cl. CPC G01N 17/00

(57) ABSTRACT

A model generation device (10) according to the present disclosure includes an inspection information acquisition unit (111) configured to acquire inspection information indicating an inspection result of a pipeline, a division unit (112) configured to divide the inspection information for each element of a surrounding environment of the pipeline, a corrosion rate calculation unit (113) configured to calculate a corrosion rate of the pipeline for each element of the surrounding environment, a pattern determination unit (114) configured to determine a pattern for each degree of the corrosion rate calculated by the corrosion rate calculation unit with respect to the divided inspection information, and a model generation unit (115) configured to generate, for each pattern, a model that outputs a pipe thickness of the pipeline corresponding to a number of elapsed years.

### TECHNICAL FIELD

The present disclosure relates to a model generation device, an estimation device, and a program.

### BACKGROUND ART

Conventionally, there are many methods for measuring the amount of metal thinning. For example, as described in Non Patent Literature 1 and Non Patent Literature 2, measurement instruments using ultrasonic waves exist for various facilities. In addition, as described in Non Patent Literature 3, for example, a method of estimating the amount of corrosive thinning using an acoustic emission method has also been studied. Meanwhile, with respect to a facility buried under the ground, the surrounding environment greatly varies depending on the position of the facility, and for example, as described in Non Patent Literature 4, the corrosiveness of the soil is evaluated by environmental factors.

### CITATION LIST

### Non Patent Literature

Non Patent Literature 1: “Pipeline Inspection by Ultrasonic and Mapping Tools”, JFE Technical Report No. 25, pp. 66-67, February 2010
Non Patent Literature 2: Dakota Japan Co., Ltd., “Measuring principle of ultrasonic thickness meter”, [online], [retrieved on Dec. 26, 2022], the Internet <URL: https://www.dakotajapan.com/thickness-gauge/point.html>
Non Patent Literature 3: Takuya Kurihara et. al., “Development of Corrosion Depth Evaluation Method in Steel Pipe by AE Method”, Materials and Environment Vol. 70, No. 2, pp. 40-46, 2021,
Non Patent Literature 4: Corrosion and corrosion protection association, Corrosion and corrosion protection handbook, pp. 204-205 Maruzen Co., Ltd., 2000

### SUMMARY OF INVENTION

### Technical Problem

However, in the conventional methods of measuring the amount of metal thinning, when one measurement result was obtained for a facility buried under the ground, it was difficult to determine how many years the facility could be used for in that environment. As described above, there has been a demand for a technique capable of predicting the lifespan of an underground facility.

An object of the present disclosure made in view of such circumstances is to provide a technique capable of predicting the lifespan of a facility buried under the ground.

### Solution to Problem

A model generation device according to the present disclosure includes: an inspection information acquisition unit configured to acquire inspection information indicating an inspection result of a pipeline; a division unit configured to divide the inspection information for each element of a surrounding environment of the pipeline; a corrosion rate calculation unit configured to calculate a corrosion rate of the pipeline for each element of the surrounding environment; a pattern determination unit configured to determine a pattern for each degree of the corrosion rate calculated by the corrosion rate calculation unit with respect to the divided inspection information; and a model generation unit configured to generate, for each pattern, a model that outputs a pipe thickness of the pipeline corresponding to a number of elapsed years.

Furthermore, an estimation device according to the present disclosure includes: a pipeline information acquisition unit configured to acquire pipeline information including a location of a target pipeline and a number of elapsed years; a model acquisition unit configured to acquire a model that outputs a pipe thickness of a pipeline corresponding to the number of elapsed years for each element of a surrounding environment; and an estimation unit configured to apply the pipeline information to the acquired model to estimate the pipe thickness of the target pipeline.

Furthermore, a program according to the present disclosure causes a computer to function as the model generation device according to the present disclosure.

Furthermore, a program according to the present disclosure causes a computer to function as the estimation device according to the present disclosure.

### Advantageous Effects of Invention

According to the present disclosure, it is possible to provide a technique capable of predicting the lifespan of a facility buried under the ground.

### BRIEF DESCRIPTION OF DRAWINGS

FIG. 1 is a diagram illustrating a schematic configuration example of a system according to the present embodiment.

FIG. 2 is a diagram for describing calculation of a corrosion rate.

FIG. 3 is a diagram illustrating an example in which locations of pipelines indicated by inspection information divided into each pattern are represented on a map.

FIG. 4A is a diagram illustrating an example of a result of plotting pipe thicknesses according to the number of elapsed years of each pipeline.

FIG. 4B is a diagram illustrating an example of a result of plotting pipe thicknesses according to the number of elapsed years of each pipeline.

FIG. 4C is a diagram illustrating an example of a result of plotting pipe thicknesses according to the number of elapsed years of each pipeline.

FIG. 5 is a diagram illustrating an example of a standard curve according to the present embodiment.

FIG. 6A is a diagram illustrating an example of a model generated by fitting,

FIG. 6B is a diagram illustrating an example of a model generated by fitting.

FIG. 6C is a diagram illustrating an example of a model generated by fitting.

FIG. 7 is a diagram for describing models having different initial values due to tolerances,

FIG. 8 is a diagram for describing calculation of the number of years of lifespan.

FIG. 9A is a diagram illustrating an operation of the system according to the present embodiment.

FIG. 9B is a diagram illustrating an operation of the system according to the present embodiment.

FIG. 10 is a diagram illustrating an example of a modified model according to the present modified example.

FIG. 11A is a diagram illustrating an operation of a system according to the present modified example.

FIG. 11B is a diagram illustrating an operation of the system according to the present modified example.

### DESCRIPTION OF EMBODIMENTS

Hereinafter, embodiments of the present disclosure will be described with reference to the drawings as appropriate. In the drawings, the same or corresponding portions are denoted by the same reference numerals. In the description of the present embodiment, the description of the same or corresponding parts will be omitted or simplified as appropriate. The embodiments described below are examples of the configuration of the present disclosure, and the present invention is not limited to the following embodiments.

### <Schematic Configuration of System 1>

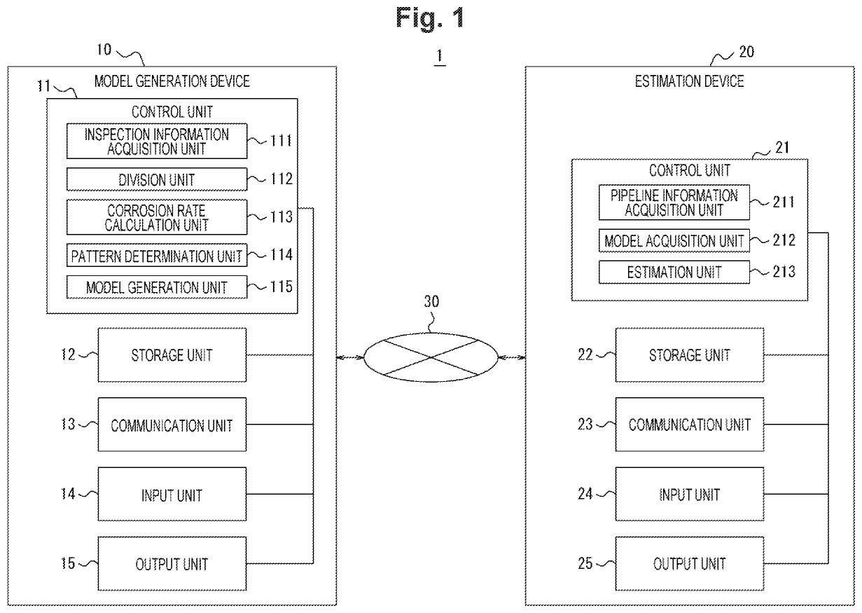

FIG. 1 is a diagram illustrating a configuration of a system 1 according to the present embodiment. As illustrated in FIG. 1, the system 1 includes a model generation device 10 and an estimation device 20. The model generation device 10 and the estimation device 20 are connected to a network 30 including, for example, the Internet, a mobile communication network, or the like in a wired or wireless manner such that they can communicate. A communication method for transmitting and receiving information between the devices is not particularly limited. The model generation device 10 and the estimation device 20 may be integrated.

The model generation device 10 and the estimation device 20 are computers such as servers belonging to a cloud computing system or another computing system.

The network 30 includes the Internet, at least one wide area network (WAN), at least one metropolitan area network (MAN), or an any combination thereof. The network 30 may include at least one wireless network, at least one optical network, or any combination thereof. The wireless network is, for example, an ad hoc network, a cellular network, a wireless local area network (LAN), a satellite communication network, or a terrestrial microwave network.

First, an overview of the present embodiment will be described, and details will be described later. The model generation device 10 acquires inspection information indicating an inspection result of a pipeline, and divides the inspection information for each element of the surrounding environment of the pipeline. The model generation device 10 calculates a corrosion rate of the pipeline for each element of the surrounding environment, and determines a pattern for each degree of the calculated corrosion rate for the divided inspection information. The model generation device 10 generates, for each pattern, a model that outputs a pipe thickness of the pipeline corresponding to a number of elapsed years. The model generation device 10 outputs the generated model to the estimation device 20.

A pipeline is a facility buried under the ground, and is, for example, a communication pipeline for protecting a communication cable. A pipeline may be a water pipeline, a gas pipeline, a power pipeline, or the like.

The estimation device 20 acquires pipeline information including the location of the target pipeline and the number of elapsed years. The estimation device 20 also acquires a model that outputs a pipe thickness of the pipeline corresponding to the number of elapsed years for each element of the surrounding environment. The estimation device 20 applies the pipeline information to the acquired model to estimate a pipe thickness of the target pipeline. The estimation device 20 further calculates the number of years of lifespan of the pipeline on the basis of the difference between the estimated pipe thickness of the pipeline and a limit thickness of the pipeline.

According to the present embodiment, it is possible to automatically generate a model capable of outputting a pipe thickness according to the number of elapsed years of a pipeline for each element of the surrounding environment of the buried pipeline. By applying information of the pipeline to be estimated to the model, it is possible to estimate the pipe thickness of the pipeline and predict the number of years of lifespan of the pipeline without actually performing an inspection. Therefore, it is possible to provide a technique capable of predicting the lifespan of a facility buried under the ground,

### <Configuration of Model Generation Device 10>

An example of a configuration of the model generation device 10 according to the present embodiment will be described with reference to FIG. 1. As illustrated in FIG. 1, the model generation device 10 includes a control unit 11, a storage unit 12, a communication unit 13, an input unit 14, and an output unit 15.

The storage unit 12 includes one or more memories, and may include, for example, a semiconductor memory, a magnetic memory, an optical memory, or the like. Each memory included in the storage unit 12 may function as, for example, a main storage device, an auxiliary storage device, or a cache memory. The storage unit 12 stores arbitrary information used for the operation of the model generation device 10. The storage unit 12 is not necessarily provided inside the model generation device 10, and may be provided outside the model generation device 10.

The communication unit 13 includes at least one communication interface. The communication interface is, for example, a LAN interface. The communication unit 13 receives information used for the operation of the model generation device 10 and transmits information obtained by the operation of the model generation device 10.

The input unit 14 includes at least one input interface. The input interface is, for example, a physical key, a capacitance key, a pointing device, a touch screen provided integrally with a display, or a microphone. The input unit 14 receives an operation of inputting information used for the operation of the model generation device 10. The input unit 14 may be connected to the model generation device 10 as an external input apparatus instead of being provided in the model generation device 10. As the connection method, for example, an arbitrary method such as universal serial bus (USB), high-definition multimedia interface (HDMI) (registered trademark), or Bluetooth (registered trademark) can be used.

The output unit 15 includes at least one output interface. The output interface is, for example, a display or a speaker. The display is, for example, a liquid crystal display (LCD) or an organic electro luminescence (EL) display. The output unit 15 may include a device that can be worn by a user, such as VR goggles. The output unit 15 outputs information obtained by the operation of the model generation device 10. The output unit 15 may be Connected to the model generation device 10 as an external output apparatus instead of being provided in the model generation device 10. As the connection method, for example, an arbitrary method such as USB, HDMI (registered trademark), or Bluetooth (registered trademark) can be used.

The control unit 11 is realized by a control arithmetic circuit (controller). The control arithmetic circuit may be configured by dedicated hardware such as an application specific integrated circuit (ASIC) or a field-programmable gate array (FPGA), may be configured by a processor, or may be configured to include both. The control unit 11 executes processing related to the operation of the model generation device 10 while controlling each unit of the model generation device 10. The control unit 11 can transmit/receive information to/from an external device via the communication unit 13 and the network 30.

The control unit 11 includes an inspection information acquisition unit 111, a division unit 112, a corrosion rate calculation unit 113, a pattern determination unit 114, and a model generation unit 115.

The inspection information acquisition unit 111 acquires inspection information indicating an inspection result of a pipeline. An arbitrary method may be adopted to acquire inspection information. For example, the inspection information acquisition unit 111 may acquire inspection information by reading the inspection information from the storage unit 12. For example, the inspection information acquisition unit 111 may acquire the inspection information by communicating with an external server device storing an inspection record and receiving the inspection information from the server device. The inspection information acquisition unit 111 outputs the acquired inspection information to the division unit 112.

Inspection information includes location information indicating the location of a pipeline, information indicating a number of elapsed years after construction of the pipeline, pipe thickness information indicating a pipe thickness which is an actual measurement value of a remaining thickness of the pipeline, corrosion information indicating presence or absence or a degree of corrosion of the pipeline, and the like. The inspection information may include information indicating a type of a pipeline such as a steel pipe, a vinyl pipe, or a cast iron pipe as a material of the pipeline.

The location information is information indicating the location of the pipeline by latitude and longitude. The present disclosure is not limited thereto, and the location information may include a depth of the pipeline from the ground surface, or the like.

The inspection information acquisition unit 111 may acquire the pipe thickness information as the inspection information by communicating with a pipe thickness measurement device installed in the pipeline and receiving information indicating the pipe thickness from the measurement device.

The corrosion information according to the present embodiment is information representing presence or absence of corrosion of the pipeline in binary. The corrosion information may be, for example, information indicated by 1 when there is corrosion and indicated by 0 when there is no corrosion. The corrosion information is not limited thereto, and may be a discrete value indicating a degree of corrosion in stages or a continuous value. The inspection information acquisition unit 111 may determine the degree or presence or absence of corrosion according to the pipe thickness indicated by the pipe thickness information, and add a determined result to the inspection information as corrosion information. For example, when the pipe thickness is less than a predetermined value, the inspection information acquisition unit 111 may add corrosion information indicating that corrosion is present to the inspection information. The predetermined value may be set in advance and stored in the storage unit 12.

The division unit 112 divides the inspection information for each element of the surrounding environment of the pipeline. Elements of the surrounding environment are categorical variables such as a river basin including the location where the pipeline is buried, a soil type, and a land use classification, but are not limited thereto. The soil type includes peat soil, developed soil, rock waste soil, and the like. The land use classification includes agricultural land, forest, wasteland, building land, and the like. For example, the surrounding environment may include the ground type, the terrain type, the water content of the soil at the location where the pipeline is buried, the acidity (pH), and the like. In the present embodiment, the surrounding environment is an area of a river in which the location of the pipeline is included, and elements of the surrounding environment are indicated by names of river basin A, river basin B, river basin C, and river basin D.

In a case where the inspection information includes information indicating the type of pipeline, the division unit 112 may divide the inspection information into the types of pipelines and then divide the inspection information for each element of the surrounding environment. As a result, it is possible to generate a model which will be described below with high accuracy depending on the type of pipeline.

The division unit 112 may acquire information indicating elements of the surrounding environment of the pipeline by receiving the information from an external server device. Specifically, the division unit 112 communicates with a server device of an administrator of basins, and transmits the location information of the pipeline included in the inspection information to the server device. The division unit 112 acquires information indicating an element of the surrounding environment of the pipeline by receiving information on a basin including the location of the pipeline identified by searching a database included in the server device. The division unit 112 may divide the inspection information for each basin received in this manner. The present disclosure is not limited thereto, and when the inspection information includes information indicating elements of the surrounding environment, the division unit 112 may divide the inspection information for each element of the surrounding environment of the pipeline on the basis of the information. The division unit 112 outputs the divided inspection information of the pipeline to the corrosion rate calculation unit 113.

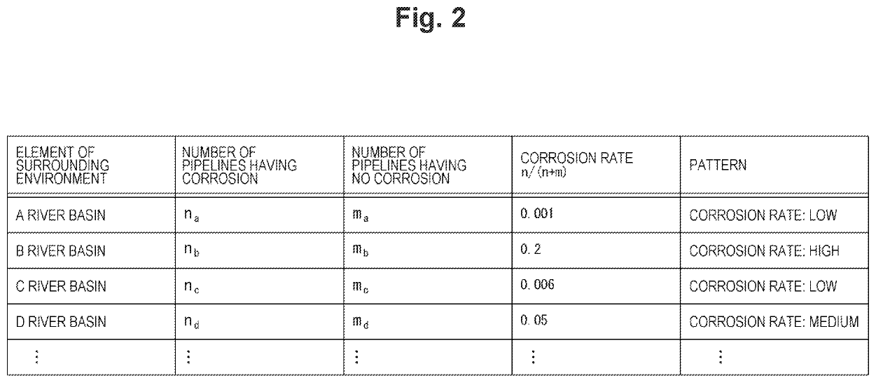

The corrosion rate calculation unit 113 calculates a corrosion rate of a pipeline for each element of the surrounding environment. The corrosion rate calculation unit 113 calculates a corrosion rate by dividing the number of pipelines having corrosion information indicating presence of corrosion among pipelines belonging to one element of the surrounding environment by the total number of pipelines belonging to the element of the surrounding environment. FIG. 2 is a diagram for describing calculation of a corrosion rate by the corrosion rate calculation unit 113. Referring to FIG. 2, the first line after the title line indicates a corrosion rate of pipelines divided into river basin A by the division unit 112. Similarly, the second line indicates a corrosion rate of pipelines divided into river basin B, the third line indicates a corrosion rate of pipelines divided into river basin C, and the fourth line indicates a corrosion rate of pipelines divided into river basin D. The total number of pipelines divided into river basin A is nₐ+mₐ, the number of pipelines having corrosion information indicating presence of corrosion is nₐ, and the number of pipelines indicating absence of corrosion is mₐ. The corrosion rate calculation unit 113 calculates a value obtained by dividing nₐ by nₐ+mₐ. The corrosion rate calculation unit 113 similarly calculates corrosion rates by performing cross tabulation with respect to the pipelines divided into river basin B, river basin C, and river basin D. In the present embodiment, the corrosion rate calculation unit 113 calculates, as the corrosion rates, a value of 0.001 for the pipelines in river basin A, a value of 0.2 for the pipelines in river basin B, a value of 0.006 for the pipelines in river basin C, and a value of 0.05 for the pipelines in river basin D. The corrosion rate calculation unit 113 outputs information indicating the calculated corrosion rates to the pattern determination unit 114.

The pattern determination unit 114 determines a pattern of divided inspection information for each degree of the corrosion rates calculated by the corrosion rate calculation unit 113. In the present embodiment, patterns are three types of patterns including “low”, “medium”, and “high” relating to the degree of a corrosion rate, but the number of patterns is not limited thereto. An arbitrary method may be adopted as a method of determining a pattern, but in the present embodiment, the pattern determination unit 114 determines a preset pattern depending on the range of values of corrosion rates. Specifically, the pattern determination unit 114 determines a pattern of a corrosion rate degree of “low” when the value of a corrosion rate is from 0.001 to 0.049, a pattern of a corrosion rate degree of “medium” when the value of the corrosion rate is from 0.050 to 0.099, and a pattern of a corrosion rate degree of “high” when the value of the corrosion rate is 0.1 or more. The pattern determination unit 114 outputs inspection information in which each pattern is determined to the model generation unit 115.

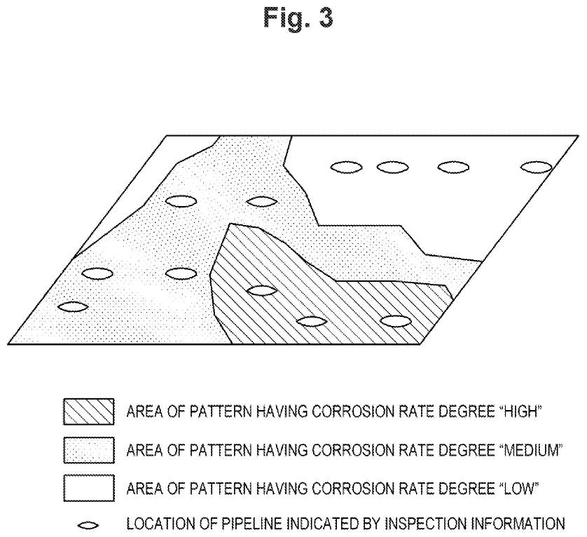

The model generation unit 115 generates a model that outputs the pipe thickness of a pipeline corresponding to the number of elapsed years for each of the patterns. FIG. 3 is a diagram illustrating an example in which the locations of pipelines indicated by inspection information determined for each pattern are represented on a map. In FIG. 3, an outlined ellipse indicates a location of each pipeline indicated by inspection information. Referring to FIG. 3, pipelines are classified into three patterns of a region of a pattern of a corrosion rate degree of “low” indicated by white, a region of a pattern of a corrosion rate degree of “medium” indicated by dots, and a region of a pattern of a corrosion rate degree of “high” indicated by diagonal lines. The boundary of the region of each pattern may be provided to correspond to a predetermined distance from the locations of pipelines.

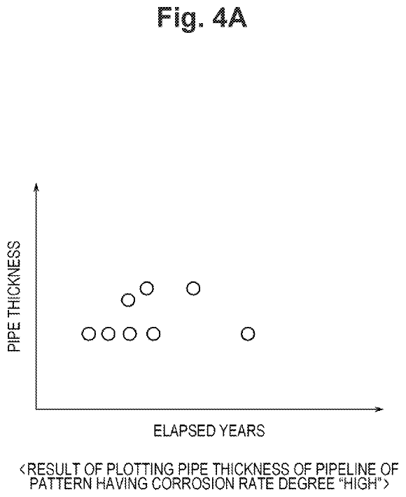

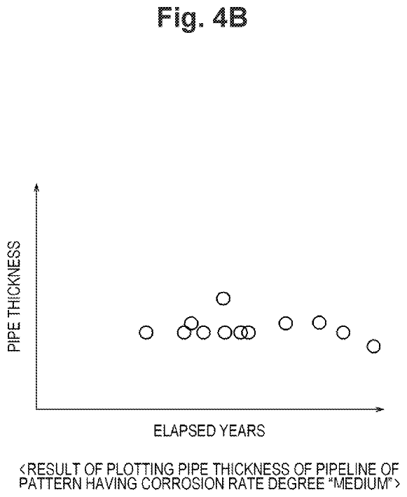

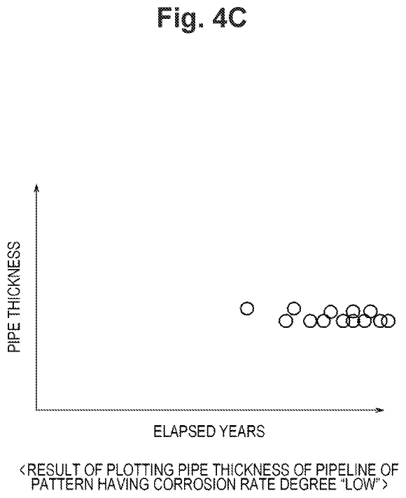

FIG. 4A to FIG. 4C illustrate examples of graphs showing results of plotting, by the model generation unit 115, pipe thicknesses according to the number of elapsed years of each pipeline for the three patterns illustrated in FIG. 3. In FIG. 4A to FIG. 4C, the horizontal axis represents the number of elapsed years of pipelines, and the vertical axis represents the pipe thicknesses of the pipelines. White circles in the graphs correspond to plotted pipelines In this manner, inspection information is determined such that it belongs to a plurality of patterns by the pattern determination unit 114, and pipe thickness inspection results are plotted.

The model generation unit 115 acquires information indicating a standard curve. A standard curve is a curve indicating change in the pipe thickness according to the number of elapsed years, and may be created in advance on the basis of experimental results and stored in the storage unit 12. In a case where the inspection information is divided for each type of pipeline, the model generation unit 115 may specify and read out a standard curve with respect to a corresponding type of pipeline from standard curves created from experimental results for each of a plurality of pipe types stored in the storage unit 12 to acquire the standard curve.

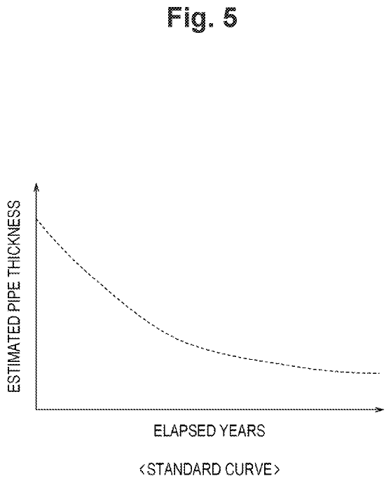

FIG. 5 shows an example in which a standard curve acquired by the model generation unit 115 is indicated by a dotted line. In FIG. 5, the horizontal axis represents the number of elapsed years of a pipeline, and the vertical axis represents an estimated value of the pipe thickness of the pipeline. Specifically, the standard curve represents a value obtained by subtracting the corrosion amount of the pipe thickness according to a reference corrosion rate from an initial value of the pipe thickness in the case of the number of elapsed years of 0. For example, in the case of a type of pipeline made of carbon steel, the corrosion rate is represented by the following formula with the corrosion amount as y as described in the following document. In the following formula, t is an elapsed year, and a and b are constants.

Document 1: Toshio Shibata, “Corrosion of Carbon Steel in Aqueous Solution”, Materials and Environment, Vol. 63, No. 4, pp. 109-115, 2014

$$\begin{matrix}[ Math . 1 ] & \\ y = {at}^{b} & ( 1 )\end{matrix}$$

Therefore, the standard curve of the pipeline is represented by the following formula using an initial value d₁ for a pipe thickness d. The initial value d₁ of the pipe thickness may vary depending on the type of the pipeline or the like. The present disclosure is not limited thereto, and an arbitrary formula may be used as a formula representing a standard curve.

$$\begin{matrix}[ Math . 2 ] & \\ d = {d}_{1} - {at}^{b} & ( 2 )\end{matrix}$$

The model generation unit 115 performs fitting by a least squares method by applying a result of plotting pipe thicknesses of each pattern to the acquired standard curve. In the present embodiment, the model generation unit 115 calculates the coefficients of a and b in the above-described formulas by fitting to generate a model. The model generation unit 115 stores the model generated for each pattern in the storage unit 12.

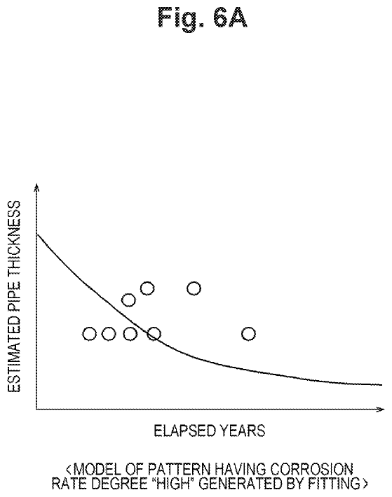

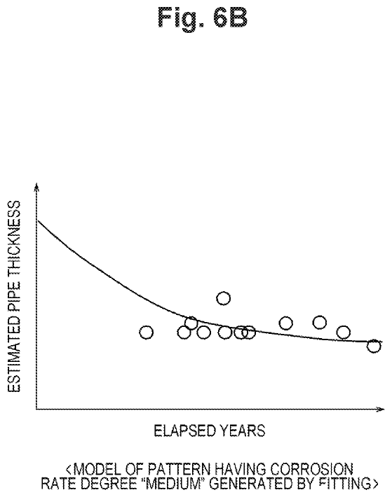

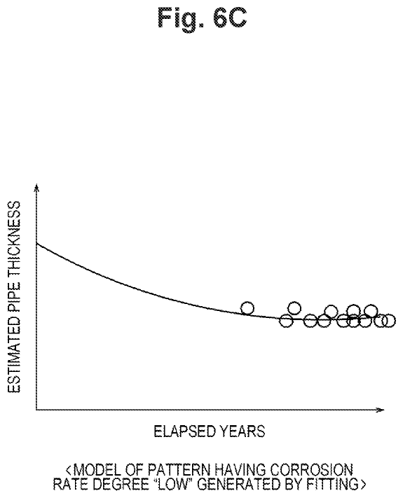

FIG. 6A to FIG. 6C illustrate examples of models generated by the model generation unit 115 for a pattern of a corrosion rate degree of “high”, a pattern of a corrosion rate degree of “medium”, and a pattern of a corrosion rate degree of “small”. As illustrated in FIG. 6A to FIG. 6C, as a result of fitting the standard curve of FIG. 5 by the model generation unit 115, different models are generated for the respective patterns.

Although fitting is performed to generate a model in which coefficients are calculated in the present embodiment, the method by which the model generation unit 115 generates a model is not limited thereto. For example, the model generation unit 115 may generate a model such as a neural network using an arbitrary machine learning method.

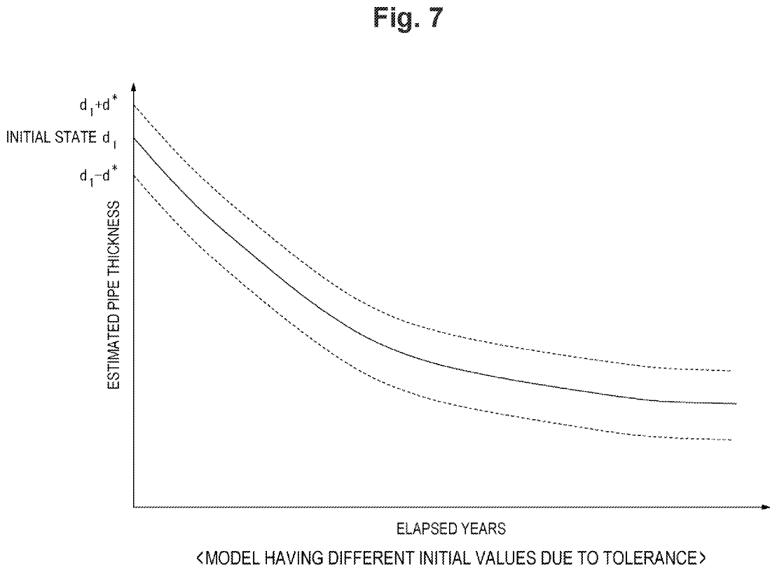

The model generation unit 115 may generate a plurality of models by changing the initial value for one pattern in consideration of a tolerance of pipe thicknesses. FIG. 7 is a diagram illustrating three types of models having different initial values when the tolerance is d* for one pattern. In addition to a model with an initial value d₁, the model generation unit 115 can generate a model with an initial value of d₁+d* and a model with an initial value of d₁−d*, which are indicated by dotted lines, and store the generated models in the storage unit 12. The tolerance may be set in advance and stored in the storage unit 12. As a result, at the time of transmitting a model from the model generation device 10 to the estimation device 20, the control unit 11 can select and read, from the storage unit 12, the model with the initial value of d₁-d* when estimating a pipe thickness assuming the worst case, the model with the initial value of d₁ when estimating a pipe thickness by a normal method, and the model with the initial value of d₁+d* when estimating a pipe thickness assuming the best case, among the three types of models, and transmit the models. Which one of the three types of models is selected by the control unit 11 may be set in advance by the user, or the control unit 11 may select a model according to a request received from the estimation device 20 each time.

### <Configuration of Estimation Device 20>

Referring back to FIG. 1, the estimation device 20 includes a control unit 21, a storage unit 22, a communication unit 23, an input unit 24, and an output unit 25.

The storage unit 22 includes one or more memories and may include, for example, a semiconductor memory, a magnetic memory, an optical memory, or the like. Each memory included in the storage unit 22 may function as, for example, a main storage device, an auxiliary storage device, or a cache memory. The storage unit 22 stores arbitrary information used for the operation of the estimation device 20. The storage unit 22 is not necessarily provided inside the estimation device 20, and may be provided outside the estimation device 20.

The communication unit 23 includes one or more communication interfaces connected to the network 30. The communication interface corresponds to, for example, a mobile communication standard, a wired LAN standard, or a wireless LAN standard, but is not limited thereto, and may correspond to any communication standard. The communication unit 23 receives information used for the operation of the estimation device 20 and transmits information obtained by the operation of the estimation device 20.

The input unit 24 includes at least one input interface. The input interface is, for example, a physical key, a capacitance key, a pointing device, a touch screen provided integrally with a display, or a microphone. The input unit 24 receives an operation of inputting information used for the operation of the estimation device 20. The input unit 24 may be connected to the estimation device 20 as an external input apparatus instead of being provided in the estimation device 20. As the connection method, for example, an arbitrary method such as USB, HDMI (registered trademark), or Bluetooth (registered trademark) can be used.

The output unit 25 includes at least one output interface. The output interface is, for example, a display or a speaker. The display is, for example, an LCD or an organic EL display. The output unit 25 outputs information obtained by the operation of the estimation device 20. The output unit 25 may be connected to the estimation device 20 as an external output apparatus instead of being included in the estimation device 20. As the connection method, for example, an arbitrary method such as USB, HDMI (registered trademark), or Bluetooth (registered trademark) can be used.

The control unit 21 is realized by a control arithmetic circuit (controller). The control arithmetic circuit may be configured by dedicated hardware such as ASIC or FPGA, may be configured by a processor, or may be configured to include both. The control unit 21 executes processing related to the operation of the estimation device 20 while controlling each unit of the estimation device 20. The control unit 21 can transmit/receive information to/from an external device via the communication unit 23 and the network 30.

The control unit 21 includes a pipeline information acquisition unit 211, a model acquisition unit 212, and an estimation unit 213.

The pipeline information acquisition unit 211 acquires pipeline information including the location of a target pipeline and the number of elapsed years. Any method may be adopted to acquire the pipeline information. For example, the pipeline information acquisition unit 211 may acquire information input by the user via the input unit 24 as pipeline information. The pipeline information acquisition unit 211 may acquire pipeline information by receiving the pipeline information from an external server device. Pipeline information may include a pipeline type. The pipeline information acquisition unit 211 outputs the acquired pipeline information to the estimation unit 213. The pipeline information acquisition unit 211 outputs information indicating the location of the pipeline to the model acquisition unit 212 on the basis of the pipeline information.

The model acquisition unit 212 acquires a model that outputs a pipe thickness of the pipeline corresponding to the number of elapsed years for each element of the the surrounding environment. In the present embodiment, model acquisition unit 212 acquires a model received from the model generation device 10. Any method may be adopted to acquire a model. For example, the model acquisition unit 212 transmits information indicating the location of the target pipeline to the model generation device 10. The model generation device 10 selects and reads a model of a corresponding pattern from the storage unit 12 on the basis of the information indicating the location and transmits the model to the estimation device 20. The model acquisition unit 212 of the estimation device 20 acquires the model by receiving the model. The model acquisition unit 212 outputs the acquired model to the estimation unit 213.

The model acquisition unit 212 may also transmit information indicating the type of the target pipeline to the model generation device 10. As a result, the control unit 11 of the model generation device 10 can receive the information, select a pattern according to the location and type of the target pipeline, and transmit the pattern to the estimation device 20.

The control unit 11 of the model generation device 10 may acquire information indicating an element of the surrounding environment of the target pipeline on the basis of the information indicating the location of the target pipeline similarly to the division unit 112 described above, read a model of the pattern corresponding to the element of the surrounding environment from the storage unit 12, and transmit the model to the estimation device 20.

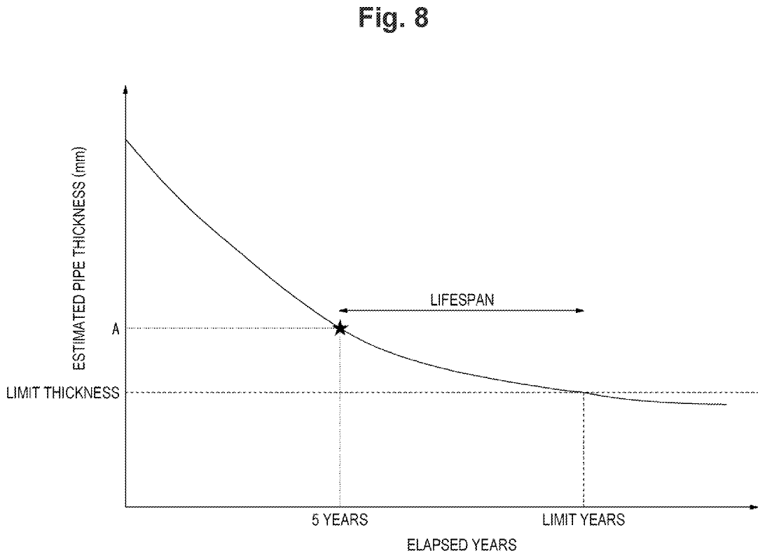

The estimation unit 213 applies the pipeline information to the acquired model to estimate a pipe thickness. For example, the number of elapsed years included in the pipeline information is five years, and the model acquisition unit 212 acquires a model illustrated in FIG. 8 related to the pattern of the corrosion degree of “high” for river basin A including the location of the pipeline, and outputs the model to the estimation unit 213. As a result of applying the pipeline information, the estimation unit 213 estimates the pipe thickness Amm corresponding to the number of elapsed years of five years, indicated by the star symbol in FIG. 8, as the pipe thickness of the target pipeline.

The estimation unit 213 calculates the number of years of lifespan of the pipeline on the basis of the difference between the pipe thickness of the pipeline calculated by the model and a limit thickness of the pipeline. The limit thickness is a minimum pipe thickness that can withstand use without causing breakage of the pipeline. The limit thickness may be set in advance and stored in the storage unit 22. For example, the limit thickness may be determined in advance by experiments performed for each type of pipeline. As illustrated in FIG. 8, the estimation unit 213 calculates a difference between five years corresponding to the estimated pipe thickness Amm and the limit year corresponding to the limit thickness as the number of years of lifespan. The estimation unit 213 may notify the user of the calculated the number of years of lifespan via the output unit 25. Any method may be adopted as a notification method.

### <Program>

In order to function as the model generation device 10 described above, it is also possible to use a computer capable of executing program instructions. Here, the computer may be a general-purpose computer, a dedicated computer, a workstation, a personal computer (PC), an electronic notebook pad, or the like. The program instructions may be program code, code segments, or the like for performing required tasks.

The computer includes a processor, a storage unit, an input unit, an output unit, and a communication interface. The processor is a central processing unit (CPU), a micro processing unit (MPU), a graphics processing unit (GPU), a digital signal processor (DSP), a system on a chip (SoC), or the like, and may be configured by a plurality of processors of the same type or different types. The processor reads and executes a program from the storage unit to perform control of each of the above-described components and various types of arithmetic processing. Note that at least a part of such processing content may be realized by hardware. The input unit is an input interface that receives an input operation of a user and acquires information based on user operation, and is a pointing device, a keyboard, a mouse, or the like. The output unit is an output interface that outputs information, and is a display, a speaker, or the like. The communication interface is an interface for communicating with an external device.

The program may be recorded in a computer-readable recording medium. By using such a recording medium, the program can be installed in a computer. Here, the recording medium on which the program is recorded may be a non-transitory recording medium. The non-transitory recording medium is not particularly limited, but may be, for example, a CD-ROM, a DVD-ROM, a USB memory, or the like. Further, the program may be downloaded from an external device via the network 30.

### <Operation of System 1>

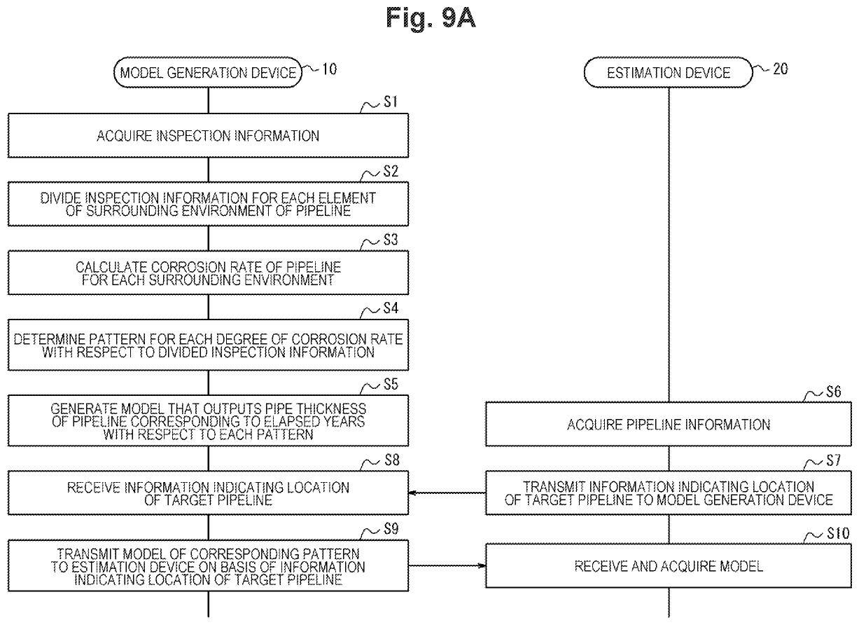

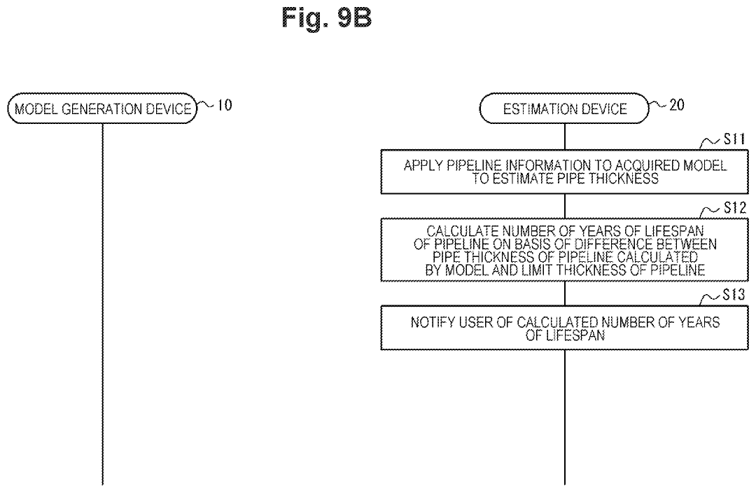

Next, operations of the system 1 including the model generation device 10 and the estimation device 20 according to the present embodiment will be described with reference to FIG. 8, FIG. 9A, and FIG. 9B. Among the operations of the system 1, the operation of the model generation device 10 corresponds to a model generation method according to the present embodiment, and the operation of the estimation device 20 corresponds to an estimation method according to the present embodiment.

In step S1 of FIG. 9A, the inspection information acquisition unit 111 of the model generation device 10 acquires inspection information indicating pipeline inspection results. An arbitrary method may be adopted to acquire inspection information. The inspection information acquisition unit 111 outputs the acquired inspection information to the division unit 112.

In step S2, the division unit 112 divides the inspection information for each element of the surrounding environment of pipelines. The division unit 112 may receive information indicating elements of the surrounding environment of the pipelines from an external server device to acquire the information and divide the information. The division unit 112 outputs the divided inspection information of the pipeline to the corrosion rate calculation unit 113.

In step S3, the corrosion rate calculation unit 113 calculates a corrosion rate of pipelines for each surrounding environment. The corrosion rate calculation unit 113 calculates a corrosion rate by dividing the number of pipelines having corrosion information indicating presence of corrosion among pipelines belonging to one element of the surrounding environment by the total number of pipelines belonging to the element of the surrounding environment. The corrosion rate calculation unit 113 outputs information indicating the calculated corrosion rates to the pattern determination unit 114.

In step S4, the pattern determination unit 114 determines a pattern for each degree of the corrosion rate calculated by the corrosion rate calculation unit 113 for the divided inspection information. The pattern determination unit 114 outputs inspection information in which each pattern is determined to the model generation unit 115.

In step S5, the model generation unit 115 generates a model that outputs pipe thicknesses of pipelines corresponding to the number of elapsed years for each pattern. Specifically, the model generation unit 115 plots pipe thicknesses according to the number of elapsed years from inspection information belonging to each pattern output from the pattern determination unit 114. The model generation unit 115 acquires information indicating a standard curve. The model generation unit 115 performs fitting using the least squares method by applying the plotted result of each pattern to the acquired standard curve. The model generation unit 115 calculates the coefficients of a and b in the above-described formula for each pattern by fitting to generate a model. The model generation unit 115 stores the model generated for each pattern in the storage unit 12.

In step S6, the pipeline information acquisition unit 211 of the estimation device 20 acquires pipeline information including the location of a target pipeline and the number of elapsed years. Any method may be adopted to acquire the pipeline information. For example, the pipeline information acquisition unit 211 may receive information input by the user via the input unit 24 and acquire the information as pipeline information. The pipeline information acquisition unit 211 outputs the acquired pipeline information to the estimation unit 213. The pipeline information acquisition unit 211 outputs information indicating the location of the target pipeline to the model acquisition unit 212.

In step S7, the model acquisition unit 212 transmits the information indicating the location of the target pipeline to the model generation device 10.

In step S8, the control unit 11 of the model generation device 10 receives the information indicating the location of the target pipeline.

In step S9, the control unit 11 reads the model of the corresponding pattern from the storage unit 12 on the basis of the information indicating the location of the target pipeline transmitted from the estimation device 20, and transmits the model to the estimation device 20.

In step S10, the model acquisition unit 212 of the estimation device 20 receives and acquires the model transmitted from the model generation device 10. The model acquisition unit 212 outputs the acquired model to the estimation unit 213.

As shown in step S7 to step S10, the model acquisition unit 212 acquires a model that outputs the pipe thickness of the pipeline corresponding to the number of elapsed years for each element of the surrounding environment.

In step S11, the estimation unit 213 applies the pipeline information to the acquired model to estimate a pipe thickness. In the present embodiment, it is assumed that the number of elapsed years of the pipeline indicated by the pipeline information acquired by the pipeline information acquisition unit 211 in step S6 is five years, and the model acquired by the model acquisition unit 212 in step S10 is the model illustrated in FIG. 8. The estimation unit 213 estimates the pipe thickness Amm as a result of application to the model.

The estimation unit 213 may notify the user of the estimated pipe thickness via the output unit 25. Any method may be adopted for the notification.

In step S12, the estimation unit 213 calculates the number of years of lifespan of the pipeline on the basis of the difference between the pipe thickness of the pipeline estimated by the model and the limit thickness of the pipeline. The limit thickness value may be set in advance. In the present embodiment, the difference between the number of elapsed years corresponding to the limit thickness of the model of FIG. 8 and five years corresponding to Amm is calculated as the number of years of lifespan.

In step S13, the control unit 11 of the estimation device 20 notifies the user of the calculated number of years of lifespan via the output unit 15. Any method may be adopted as a notification method. Thereafter, the operation of the system 1 ends.

As described above, the model generation device 10 of the present embodiment includes the inspection information acquisition unit 111 that acquires inspection information indicating pipeline inspection results, the division unit 112 that divides the inspection information for each element of the surrounding environment of pipelines, the corrosion rate calculation unit 113 that calculates a corrosion rate of the pipelines for each element of the surrounding environment, the pattern determination unit 114 that determines a pattern for each degree of the corrosion rate calculated by the corrosion rate calculation unit 113 for the divided inspection information, and the model generation unit 115 that generates a model that outputs pipe thicknesses of the pipelines corresponding to the number of elapsed years for each pattern.

According to the model generation device 10 of the present embodiment, it is possible to generate a model that outputs pipe thicknesses of pipelines corresponding to the number of elapsed years. The model generation device 10 generates a highly accurate model that is divided for each element of the surrounding environment and further patterned on the basis of the corrosion rate. When the model is used, it is possible to reduce the inspection cost without actually measuring pipe thicknesses, and it is easy to specify a pipeline having a short lifespan on the basis of the pipe thicknesses. Therefore, it is possible to provide a technique that enables prediction of the lifespan of an underground facility.

As described above, the estimation device 20 of the present embodiment includes the pipeline information acquisition unit 211 that acquires pipeline information including the location of a target pipeline and the number of elapsed years, the model acquisition unit 212 that acquires a model that outputs the pipe thicknesses of the pipeline corresponding to the number of elapsed years for each element of the surrounding environment, and the estimation unit 213 that applies the pipeline information to the acquired model to estimate the pipe thickness of the target pipeline.

According to the estimation device 20 of the present embodiment, it is possible to acquire a model that outputs pipe thicknesses on the basis of the number of elapsed years of pipelines and automatically apply pipeline information of the target pipeline to the acquired model. Since it is possible to efficiently estimate the pipe thickness only by inputting information of the target pipeline, it is possible to provide a technique capable of predicting the lifespan of the pipeline.

As described above, in the estimation device 20 of the present embodiment, the estimation unit 213 calculates the number of years of lifespan of a pipeline on the basis of the difference between the estimated pipe thickness and the limit thickness of the pipeline.

According to the estimation device 20 of the present embodiment, after the pipe thickness of the target pipeline is estimated, the number of years until the limit thickness is automatically reached can be easily calculated as the number of years of lifespan on the basis of the model. Therefore, it is possible to provide a technique capable of predicting the lifespan of the pipeline.

Although the present invention has been described based on the drawings and embodiments, it should be noted that those skilled in the art can easily make various modifications or corrections based on the present invention. Therefore, it should be noted that these variations and modifications are included in the scope of the present invention.

### Modified Example

Next, a modified example of the embodiment of the present disclosure will be described. In the present modified example, the model generation device 10 corrects a model on the basis of the actual measurement value of the pipe thickness of a pipeline.

The control unit 11 of the model generation device 10 according to the present modified example acquires pipeline information of the target pipeline estimated by the estimation device 20 by receiving the pipeline information from the estimation device 20. The control unit 11 further acquires pipe thickness information indicating a pipe thickness which is an actual measurement value of the remaining thickness of the target pipeline and corrosion information indicating presence or absence or degree of corrosion of the target pipeline. Any method may be adopted to acquire the pipe thickness information and the corrosion information. For example, the control unit 11 may acquire the pipe thickness information and the corrosion information by communicating with a terminal device used by an inspector of the target pipeline and receiving the pipe thickness information and the corrosion information. The control unit 11 outputs the pipeline information, the pipe thickness information, and the corrosion information to the model generation unit 115. The model generation unit 115 acquires the pipeline information, the pipe thickness information, and the corrosion information as inspection information, and generates a model that outputs pipe thicknesses from the number of elapsed years by a method similar to the above-described method to correct the model. Specifically, a model of a corresponding pattern is re-generated by performing fitting again by applying a result of newly plotting actual measurement values to a standard curve.

The present disclosure is not limited thereto, and the control unit 11 may determine whether or not a difference between the actual measurement value of the pipe thickness of the target pipeline indicated by the pipe thickness information and an estimated value of the pipe thickness of the target pipeline estimated by the estimation device 20 is a predetermined value or more, and determine to correct the model when it is determined that the difference is the predetermined value or more, and the model generation unit 115 may correct the model. The predetermined value may be set in advance by the user and stored in the storage unit 12. The model generation unit 115 may correct the model every predetermined period, or may correct the model each time pipeline information, pipe thickness information, and corrosion information are input.

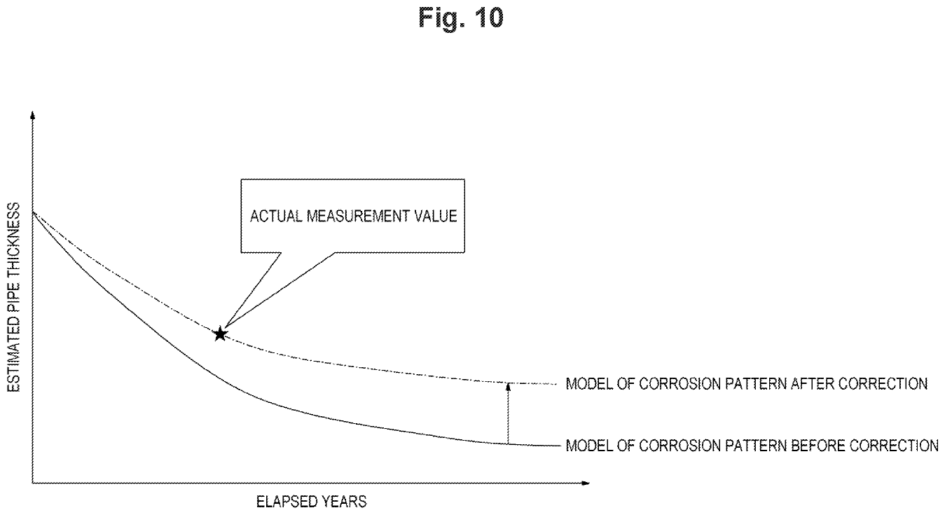

FIG. 10 is a diagram illustrating an example of a model corrected by the model generation unit 115. Referring to FIG. 10, the model indicated by the solid line is corrected to the model of the dotted line capable of calculating the value of the actual measurement value of the pipe thickness indicated by the star.

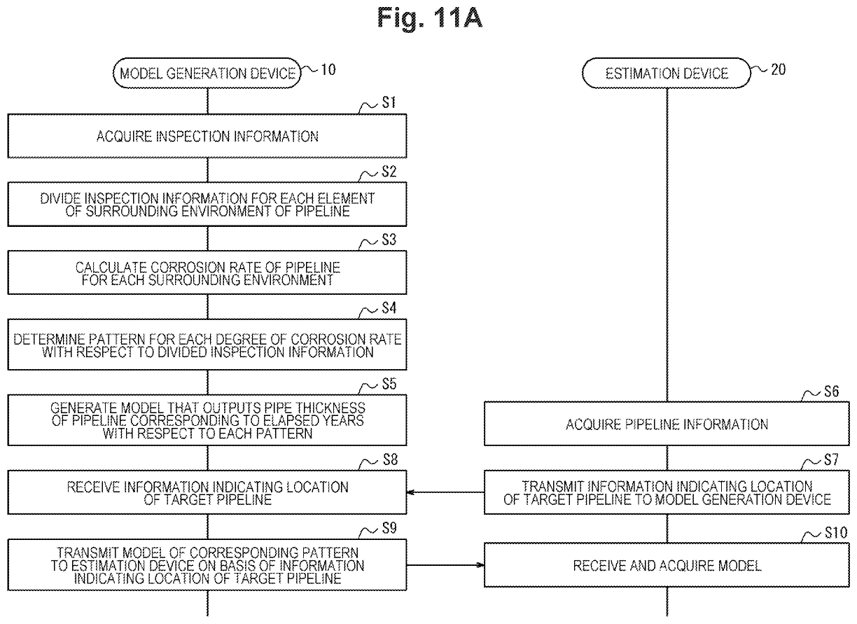

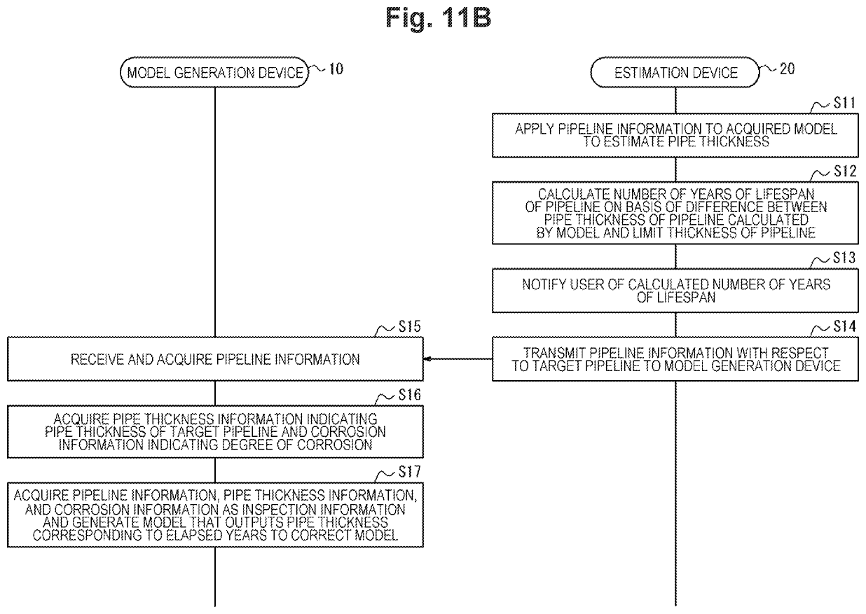

Hereinafter, a difference between the operation of the system 1 according to the above-described embodiment and the operation of the system 1 according to the present modified example will be described with reference to FIG. 11A and FIG. 11B.

Steps S1 to S13 in FIG. 11A and FIG. 11B are similar to steps S1 to S13 in FIG. 9A and FIG. 9B according to the above-described embodiment, and thus description thereof is omitted.

In step S14 in FIG. 11B, the control unit 11 of the estimation device 20 transmits pipeline information on the target pipeline to the model generation device 10.

In step S15, the control unit 11 of the model generation device 10 receives and acquires pipeline information.

In step S16, the control unit 11 further acquires pipe thickness information and corrosion information on the target pipeline. Any method may be adopted to acquire the pipe thickness information and the corrosion information. The control unit 11 outputs the pipeline information, the pipe thickness information, and the corrosion information to the model generation unit 115.

In step S17, the model generation unit 115 acquires the pipeline information, the pipe thickness information, and the corrosion information as inspection information, and generates a model that outputs pipe thicknesses Corresponding to the number of elapsed years using the same method as in steps S1 to S5 described above to correct the model. The model generation unit 115 stores the corrected model in the storage unit 12. The model generation unit 115 may overwrite the model before correction with the corrected model and store the model in the storage unit 12. Thereafter, the operation of the system 1 ends.

According to the present modified example, the corrected model is stored in the storage unit 12 of the model generation device 10, and is transmitted to the estimation device 20 at the time of estimating a pipe thickness of the target pipeline next time. The model acquisition unit 212 of the estimation device 20 receives the corrected model to acquire the corrected model, and can use the corrected model to estimate the pipe thickness of the target pipeline. According to the system 1 according to the present modified example, since the model can be automatically corrected using the actual measurement value of the pipe thickness, it is possible to estimate the pipe thickness of the pipeline with higher accuracy.

With regard to the above embodiments, the following supplements are further disclosed.

### (Supplement 1)

A model generation device including a control unit configured to:
acquire inspection information indicating an inspection result of a pipeline;
divide the inspection information for each element of a surrounding environment of the pipeline;
calculate a corrosion rate of the pipeline for each element of the surrounding environment;
determine a pattern for each degree of the calculated corrosion rate with respect to the divided inspection information; and
generate a model that outputs a pipe thickness of the pipeline corresponding to a number of elapsed years for each pattern.

### (Supplement 2)

An estimation device including a control unit configured to:
acquire pipeline information including a location of a target pipeline and a number of elapsed years;
acquire a model that outputs a pipe thickness of a pipeline corresponding to the number of elapsed years for each element of a surrounding environment; and
apply the pipeline information to the acquired model to estimate the pipe thickness of the target pipeline.

### (Supplement 3)

The estimation device according to supplement 2, wherein the control unit calculates a number of years of lifespan of the pipeline on the basis of a difference between the estimated pipe thickness and a limit thickness of the pipeline.

### (Supplement 4)

A non-transitory computer-readable medium storing a program for causing a computer to function as the model generation device according to supplement 1.

### (Supplement 5)

A non-transitory computer-readable medium storing a program for causing a computer to function as the estimation device according to supplement 2 or 3.

### REFERENCE SIGNS LIST

1 System
10 Model generation device
11 Control unit
12 Storage unit
13 Communication unit
14 Input unit
15 Output unit
20 Corrosion prediction device
21 Control unit
22 Storage unit
23 Communication unit
24 Input unit
25 Output unit
30 Network
111 Inspection information acquisition unit
112 Division unit
113 Corrosion rate calculation unit
114 Pattern determination unit
115 Model generation unit
211 Pipeline information acquisition unit
212 Model acquisition unit
213 Estimation unit

1. A model generation device comprising:
at least one processor; and
memory storing instructions that, when executed by the at least one processor, causes the device to perform a set of operations the set of operations comprising:
acquiring inspection information indicating an inspection result of a pipeline;
dividing the inspection information for each element of a surrounding environment of the pipeline;
calculating a corrosion rate of the pipeline for each element of the surrounding environment;
determining a pattern for each degree of the corrosion rate calculated by the corrosion rate calculation unit with respect to the divided inspection information; and
generating, for each pattern, a model that outputs a pipe thickness of the pipeline corresponding to a number of elapsed years.

2. An estimation device comprising:
at least one processor; and
memory storing instructions that, when executed by the at least one processor, causes the device to perform a set of operations the set of operations comprising:
acquiring pipeline information including a location of a target pipeline and a number of elapsed years;
acquiring a model that outputs a pipe thickness of a pipeline corresponding to the number of elapsed years for each element of a surrounding environment; and
applying the pipeline information to the acquired model to estimate the pipe thickness of the target pipeline.

3. The estimation device according to claim 2, wherein a number of years of lifespan of the pipeline is calculated on the basis of a difference between the estimated pipe thickness and a limit thickness of the pipeline.

4. A program for causing a computer to function as the model generation device according to claim 1.

5. A program for causing a computer to function as the estimation device according to claim 2.

6. The model generation device according to claim 1, wherein the inspection information comprises location of the pipeline, information indicating number of years since the pipeline was constructed, pipe thickness information indicating the pipe thickness which is the actual measured value of the remaining thickness of the pipeline, and corrosion information indicating the presence or absence or the degree of corrosion of the pipeline.

7. The model generation device according to claim 6, wherein the location information indicates latitude, longitude and depth of the pipeline.

8. The model generation device according to claim 6, wherein the corrosion information is information that expresses the presence or absence of corrosion in a pipeline as a binary value.

9. The model generation device according to claim 1, further comprising:
receiving elements of the surrounding environment of the pipeline from an external server.

10. The model generation device according to claim 1, further comprising:
generating a neural network model using machine learning method.

11. The estimation device according to claim 2, wherein the inspection information comprises location of the pipeline, information indicating number of years since the pipeline was constructed, pipe thickness information indicating the pipe thickness which is the actual measured value of the remaining thickness of the pipeline, and corrosion information indicating the presence or absence or the degree of corrosion of the pipeline.

12. The estimation device according to claim 11, wherein the location information indicates latitude, longitude and depth of the pipeline.

13. The estimation device according to claim 11, wherein the corrosion information is information that expresses the presence or absence of corrosion in a pipeline as a binary value.

14. The estimation device according to claim 2, further comprising:
receiving elements of the surrounding environment of the pipeline from an external server.

15. The estimation device according to claim 2, further comprising:
generating a neural network model using machine learning method.

16. A computer-readable non-transitory recording medium storing computer-executable program instructions that when executed by a processor cause a computer to execute a program generation method comprising:
acquiring inspection information indicating an inspection result of a pipeline;
dividing the inspection information for each element of a surrounding environment of the pipeline;
calculating a corrosion rate of the pipeline for each element of the surrounding environment;
determining a pattern for each degree of the corrosion rate calculated by the corrosion rate calculation unit with respect to the divided inspection information; and
generating, for each pattern, a model that outputs a pipe thickness of the pipeline corresponding to a number of elapsed years.

17. The computer-readable non-transitory recording medium according to claim 16, wherein the inspection information comprises location of the pipeline, information indicating number of years since the pipeline was constructed, pipe thickness information indicating the pipe thickness which is the actual measured value of the remaining thickness of the pipeline, and corrosion information indicating the presence or absence or the degree of corrosion of the pipeline.

18. The computer-readable non-transitory recording medium according to claim 17, wherein the location information indicates latitude, longitude and depth of the pipeline.

19. The computer-readable non-transitory recording medium according to claim 17, wherein the corrosion information is information that expresses the presence or absence of corrosion in a pipeline as a binary value.

20. The estimation device according to claim 16, further comprising:
receiving elements of the surrounding environment of the pipeline from an external server.
